(19) United States
(12) Patent Application Publication
(10) Pub. No.: US 2019/0270208 A1
(43) Pub. Date: Sep. 5, 2019

(54) Low Friction Pivot Assembly for Scissors

(71) Applicant: Acme United Corporation, Fairfield, CT (US)

(72) Inventor: Nicholas L. Seferi, Southbury, CT (US)

(21) Appl. No.: 15/909,172

(22) Filed: Mar. 1, 2018

(51) Int. Cl. B26B 13/28

(52) U.S. Cl. CPC B26B 13/28

(57) ABSTRACT

A low-friction hub assembly for pivotally connecting a pair of scissors employs a pair of cooperative hub nuts. A first hub nut has an exterior threaded surface which threadably engages with an interior threaded surface of the second hub nut. Each of the hub nuts has annular shoulders which engage against opposed annular surfaces of surrounding aligned pivot openings of the scissors. A pair or opposed pawls engages a serrated surface to lock the subassembly. A throughbore extends through the pivot assembly.

### BACKGROUND

This disclosure relates generally to a pair of lever-like scissors which are pivotally joined to provide a cutting tool. More particularly, this disclosure relates to techniques and assemblies for implementing a pivotal connection between scissors.

Scissor technology is well developed and numerous proposals have been advanced for implementing a pivot assembly for lever-like scissor assemblies which have numerous configurations. It has long been a desirable objective to provide a pivot assembly which provides a low friction operation, is formed from relatively inexpensive components and is efficiently assembled during the scissor manufacturing process.

### SUMMARY

Briefly stated, a low friction hub for pivotally connecting a pair of scissors comprises a first hub nut and a second hub nut. The first hub nut comprises a sleeve defining a cylindrical bore and having an exterior threaded surface and a circumferential serrated surface. A head integrally extends at a top of the sleeve and defines an annular shoulder projecting radially from the sleeve and having a tapered upper surface terminating in a peripheral rim and having an inwardly angled surface adjacent the bore and interrupted by a pair of opposed slots. The second hub nut comprises a sleeve having a cylindrical exterior surface and defining an interior threaded bore and opposed axially projecting pawls. A head integrally extends at a bottom of the sleeve and defines an annular shoulder projecting radially from the sleeve. The second nut head has a tapered lower surface terminating in a peripheral rim and an inwardly angled surface adjacent the threaded bore and interrupted by a pair of opposed slots. The second hub nut threadably receives the first hub nut so that the pawls engage the first hub nut serrated surface and a central throughbore traverses through the first and second hub nuts.

The pawls each have a V-shaped section. An annular recess is preferably disposed between the serrated surface and the exterior threaded surface of the first hub nut. The first hub nut head and the second hub nut head are substantially identical. Multiple angularly spaced dimples are defined in the first hub nut head and the second hub nut head.

A low friction hub for pivotally connecting a pair of scissors comprises a first hub nut and a second hub nut. The first hub nut comprises a sleeve defining a cylindrical bore. The sleeve has an exterior threaded surface and a circumferential serrated surface. A head integrally extends at a top of the sleeve and defines an annular shoulder projecting radially from the sleeve. The head has an upper surface terminating in a peripheral rim and extending to the cylindrical bore. The second hub nut comprises a sleeve having a cylindrical exterior surface and defining an interior threaded bore and at least one axially projecting pawl. A second nut head integrally extends at a bottom of the sleeve and defines an annular shoulder projecting radially from the sleeve. The second nut head has a lower surface terminating in a peripheral rim and extending to the threaded bore. The hub nut threadably receives the first hub nut so that at least one pawl engages the hub nut serrated surface and a central throughbore traverses through the first and second hub nuts.

There are preferably two opposed pawls each having a V-shaped section. An annular recess is disposed between the serrated surface and the exterior threaded surface of the first hub nut. The first hub nut head and the second hub nut head are substantially identical. Each head defines a pair of opposed slots. The upper and lower surface of the first and second heads each respectively extends inwardly toward the throughbore.

A pair of scissors comprises a lever-like thumb subassembly which defines a first circular opening having a first diameter and a first annular surface surrounding the opening. A lever-like finger assembly defines a second circular opening having a diameter equal to the first diameter and a second annular surface surrounding the opening.

A first hub nut comprises a sleeve defining a cylindrical bore and having an exterior threaded surface and a circumferential serrated surface. A head integrally extends at a top of the sleeve and defines an annular shoulder projecting radially from the sleeve. The head has an upper surface terminating at a peripheral rim and has an inwardly angled surface adjacent the bore that is interrupted by a pair of opposed slots.

A second hub nut comprises a sleeve having an exterior cylindrical surface having a diameter substantially equal to the first opening diameter. The second hub nut sleeve defines an interior threaded bore and has opposed axially projecting pawls. A second nut head integrally extends at a bottom of the sleeve and defines an annular shoulder projecting radially from the sleeve. The second nut head has a lower surface and terminating at a peripheral rim and has an inwardly angled surface adjacent the bore that is interrupted by a pair of opposed slots.

The pawls preferably have a V-shaped section. The head of the first hub nut and the head of the second hub nut are substantially identical. The second hub nut defines an inward lip and the bore is threaded to a position adjacent the lip. The slots are oriented obliquely relative to each nut head. The upper surface and the lower surface each have multiple angularly spaced dimples.

### BRIEF DESCRIPTION OF THE DRAWINGS

FIG. 1 is a perspective view of a pair of scissors which employs a low friction pivot assembly;

FIG. 2 is an exploded view of the scissors and pivot assembly of FIG. 1;

FIG. 3 is an enlarged perspective view of a hub nut employed in the pivot assembly of FIG. 1;

FIG. 4 is a side elevational view of the hub nut of FIG. 3;

FIG. 5 is a bottom plan view, partly in phantom, of the hub nut of FIG. 3;

FIG. 6 is an enlarged perspective view of second hub nut employed in the pivot assembly of FIG. 1;

FIG. 7 is a side elevational view, partly in phantom, of the hub nut of FIG. 6;

FIG. 8 is a bottom plan view, partly in phantom, of the hub nut of FIG. 6;

FIG. 9 is a side sectional view of the hub nut of FIG. 7, taken along the line E-E thereof;

FIG. 10 is an annotated top view of a thumb loop subassembly for the scissors of FIG. 1;

FIG. 11 is a sectional view of the thumb loop subassembly taken along the line B-B of FIG. 10;

FIG. 12 is a side view of the thumb loop subassembly of FIG. 11;

FIG. 13 is a bottom plan view of the thumb loop subassembly of FIG. 10;

FIG. 14 is a top plan view of the finger loop subassembly for the scissors of FIG. 1;

FIG. 15 is an sectional view of the finger loop subassembly taken along the line D-D of FIG. 14;

FIG. 16 is a side view of the finger loop subassembly of FIG. 15;

FIG. 17 is a bottom plan view of the finger loop subassembly of FIG. 14;

FIG. 18 is a top plan view of the scissors of FIG. 1 in a closed position;

FIG. 19 is a bottom plan view of the scissors of FIG. 18;

FIG. 20 is a top plan view of the scissors of FIG. 18 showing various section lines;

FIG. 21 is an enlarged sectional view taken along the line A-A of FIG. 20; and

FIG. 22 is an enlarged sectional view taken along the line B-B of FIG. 20.

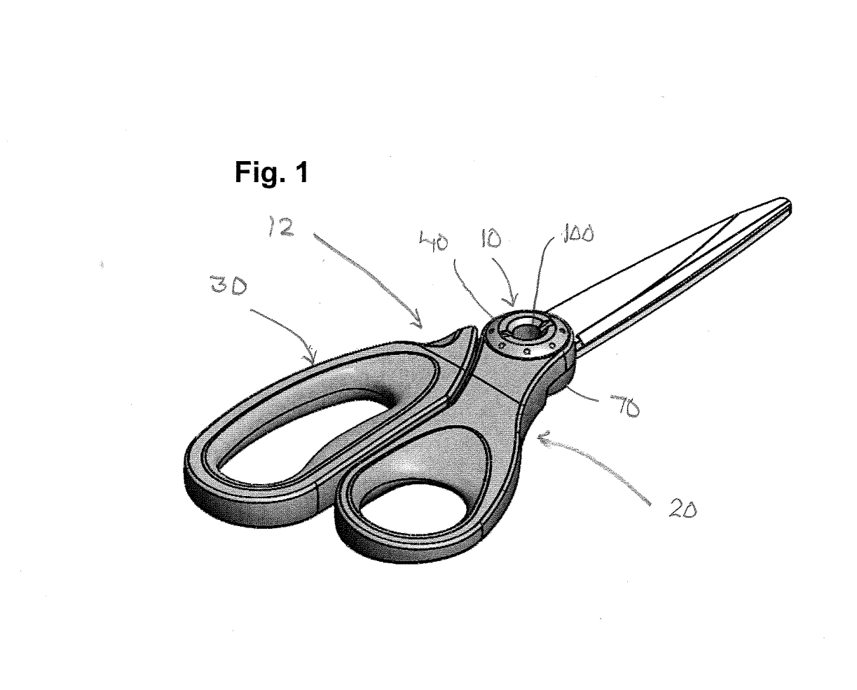

### DETAILED DESCRIPTION

With reference to the drawings wherein like numerals represent like parts throughout the figures, a low friction pivot assembly generally designated by the numeral 10 is employed with a representative pair of scissors 12. Numerous other scissor embodiments and pivoted cutter components may be employed with the low friction pivot assembly 10 which has numerous applications.

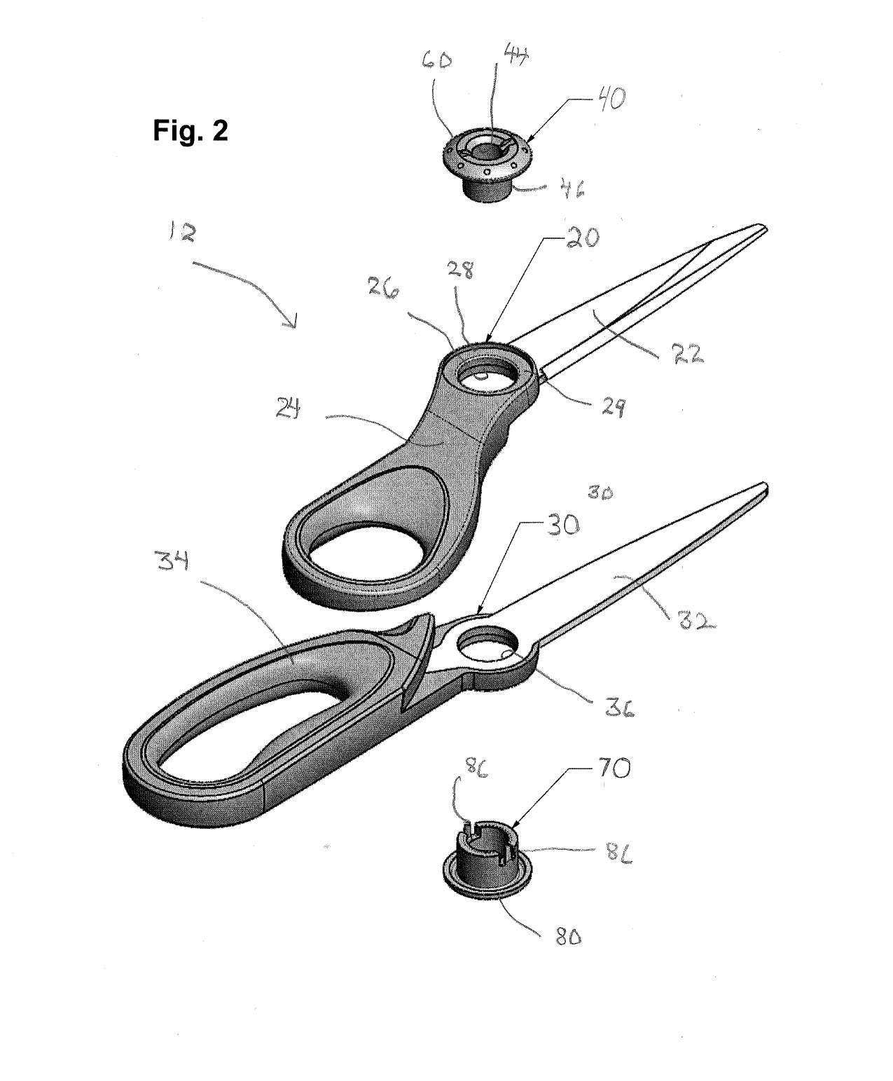

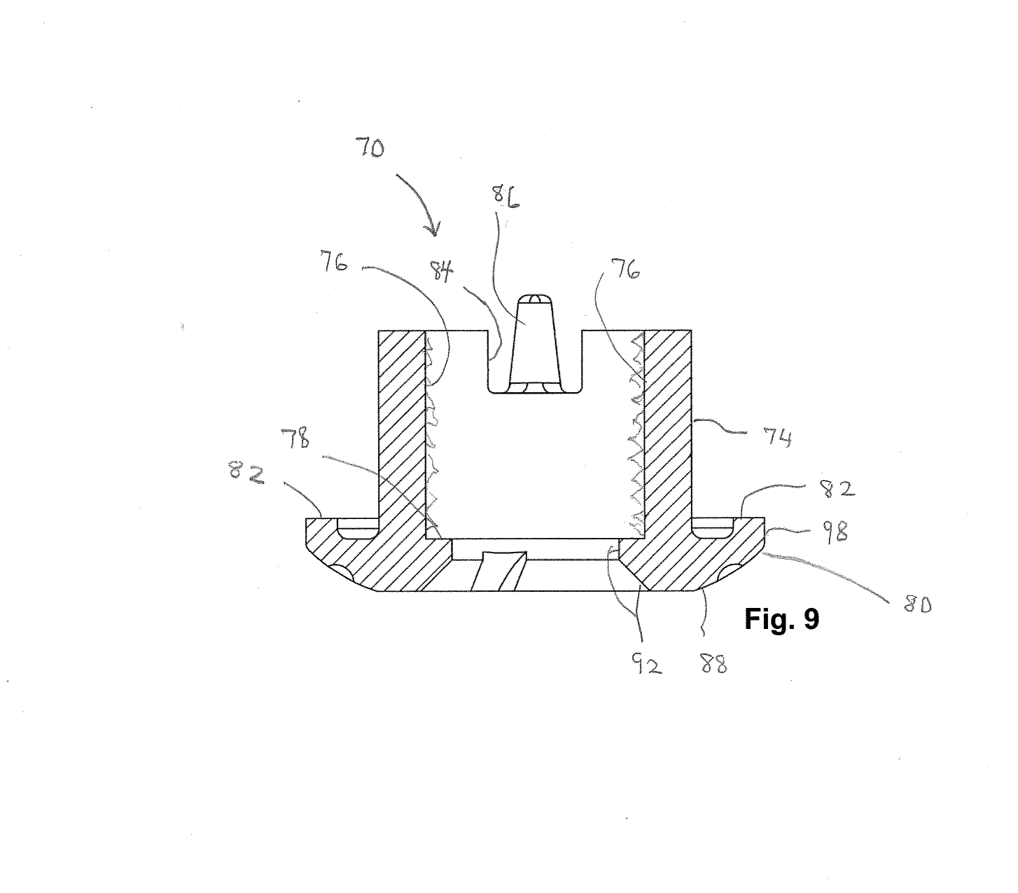

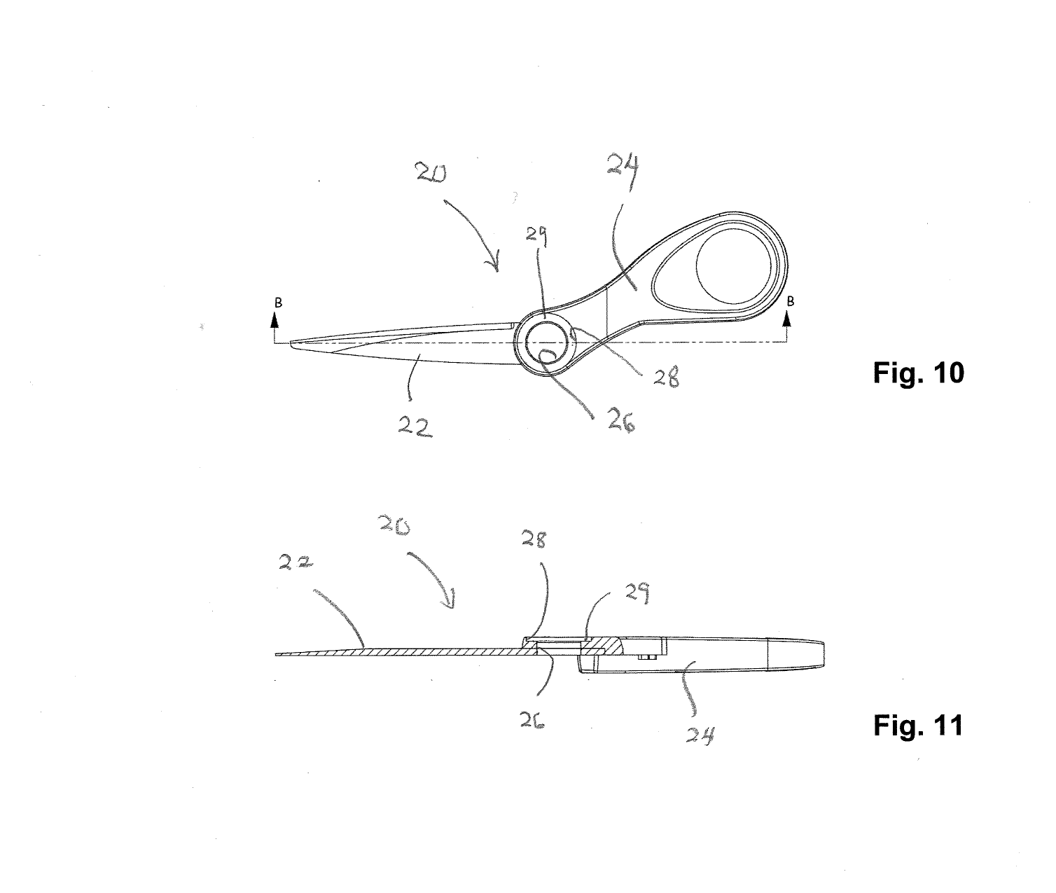

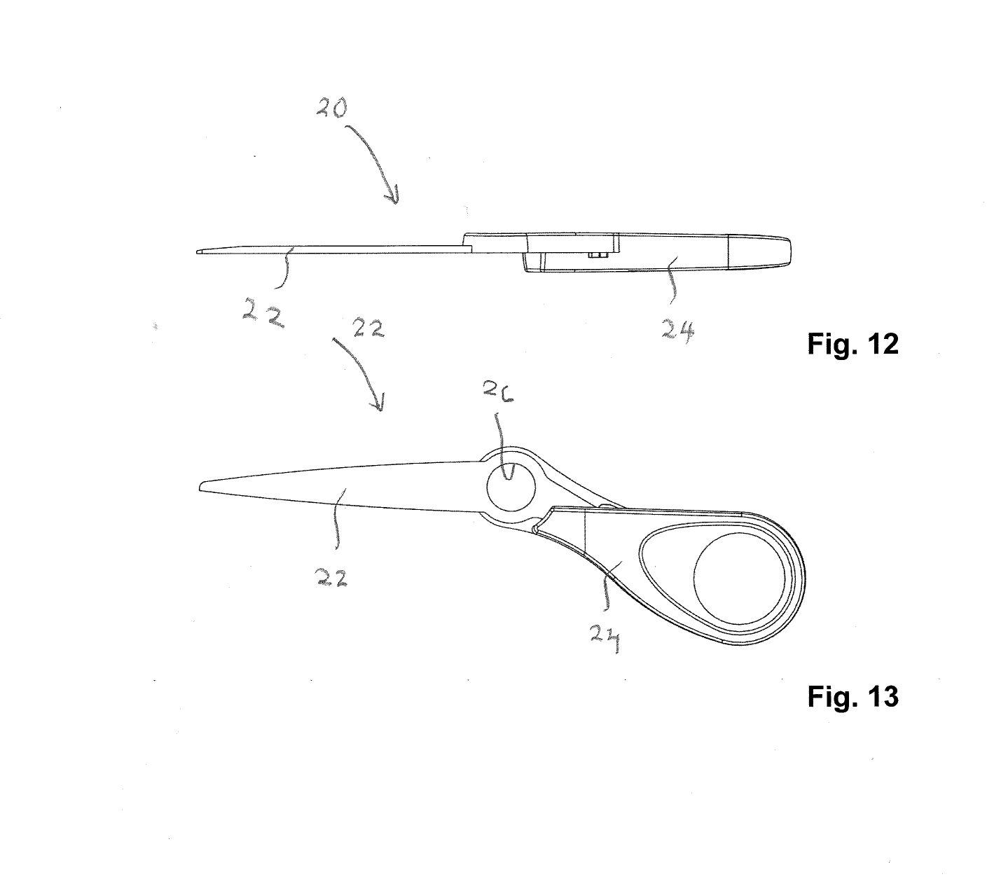

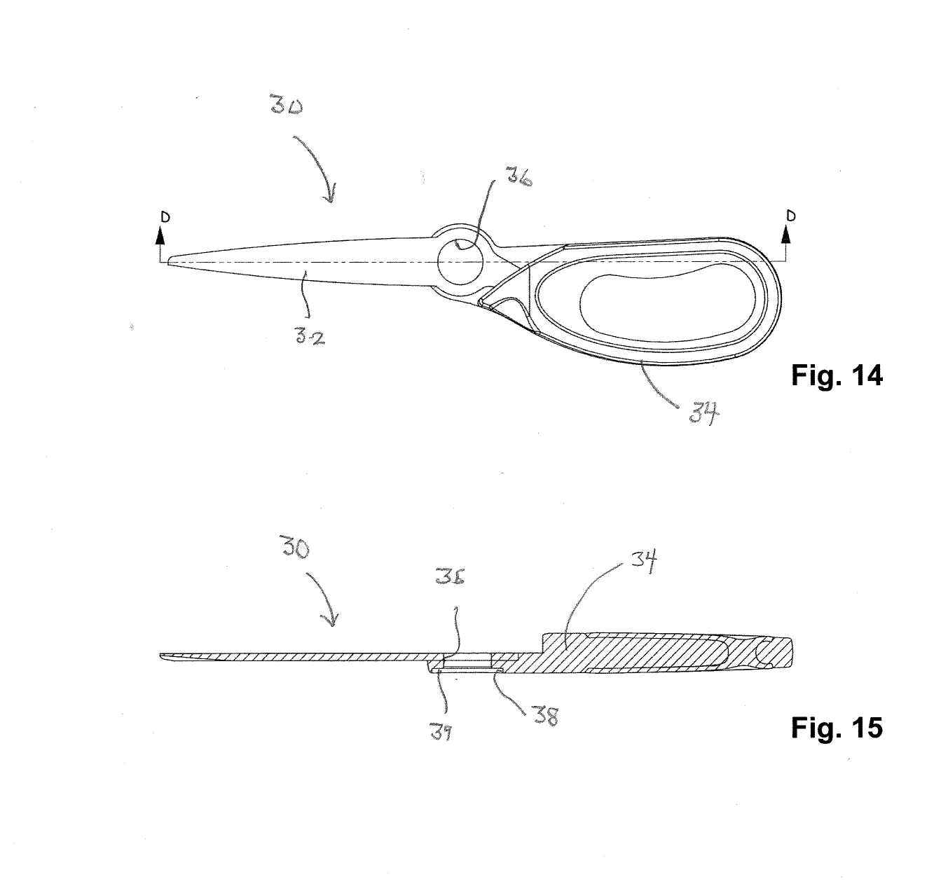

The scissors 12 employ a lever-like thumb blade assembly 20 which comprises a metal blade 22 secured by a thumb loop subassembly 24 comprising an elongated finger loop (see FIGS. 2, 10-14). A central pivot opening 26 of uniform diameter is defined in the blade assembly 20. The reverse side of the thumb loop subassembly has an annular recess 28 partially defined by a planar annulus 29 which surrounds the pivot opening 26.

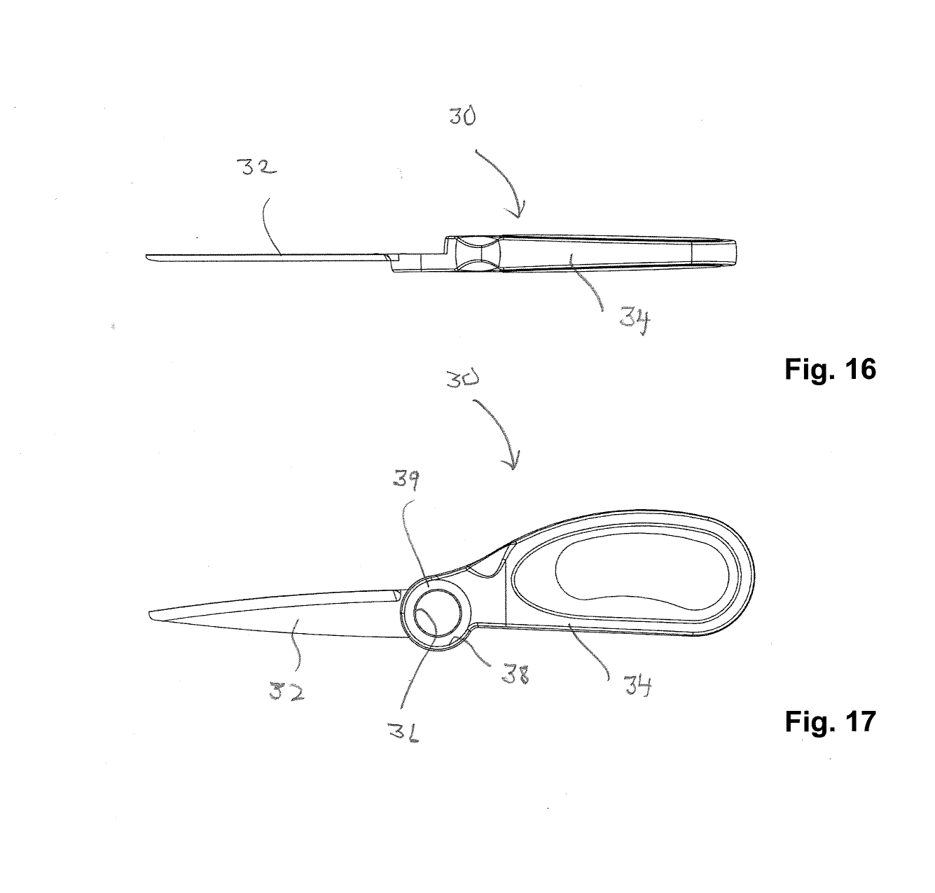

A lever-like finger loop subassembly 30 includes a metal blade 32 attached to a finger loop subassembly 34 which includes a finger opening (see FIGS. 2, 14-17). A central pivot opening 36 extends through the handle subassembly and the blade. An annular recess 38 partially defined by a planar annulus 39 surrounds the pivot opening 36.

The low friction pivot assembly 10 comprises a first male hub nut 40 and a female hub nut 70 which threadably and lockably engage and extend through the openings 26 and 36, as will be further described below. The designations of upper and lower and top and bottom and are arbitrary in describing each hub nut. The noted positions are principally described herein consistent with the component positions of FIG. 2.

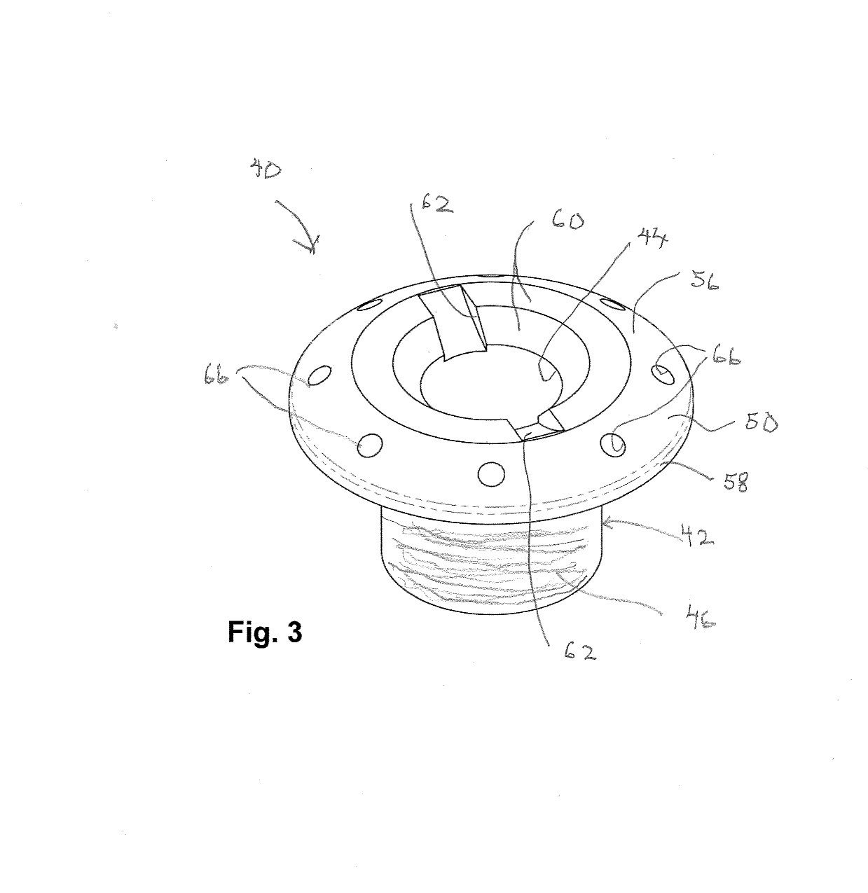

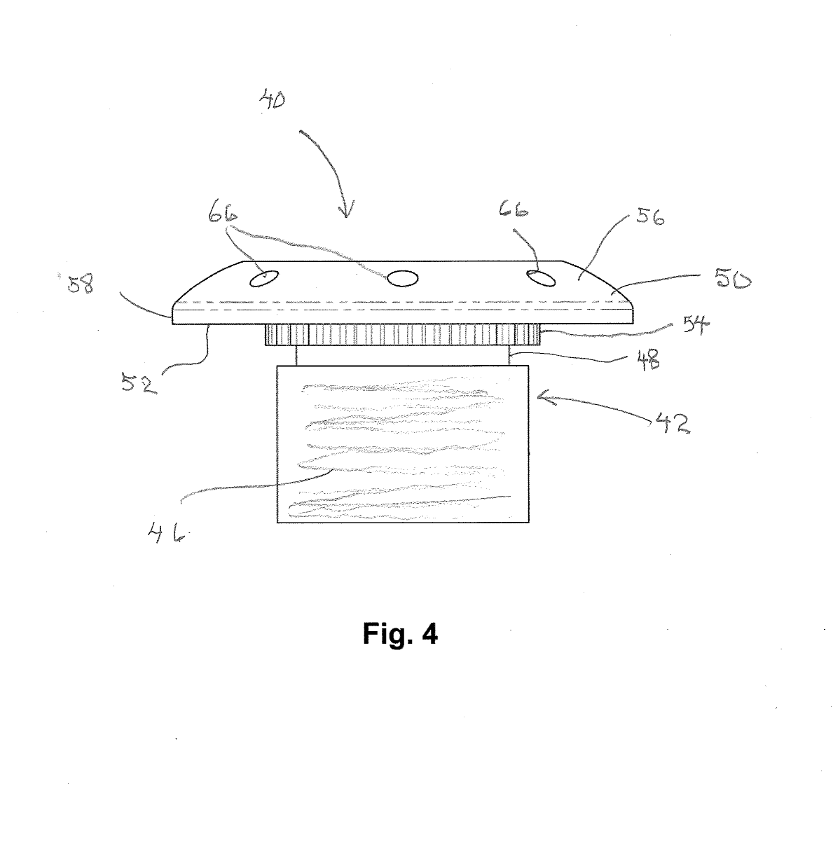

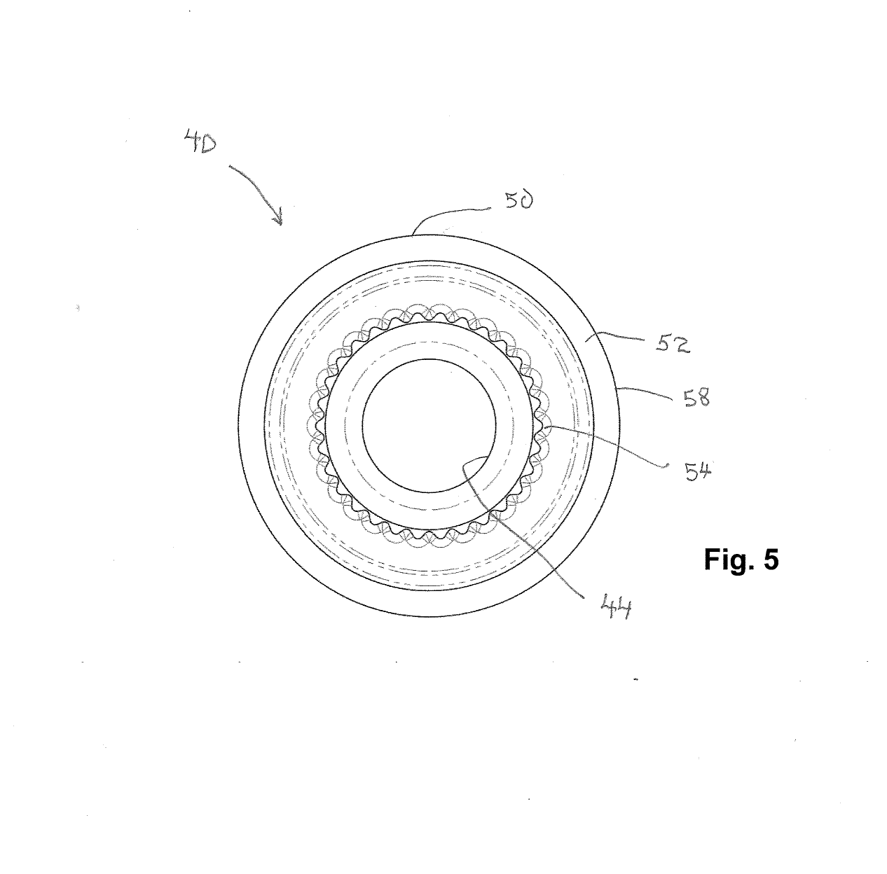

With additional reference to FIGS. 3-5, the male hub nut 40 comprises a generally cylindrical sleeve 42 which defines a cylindrical throughbore 44 and has an exterior threaded surface 46. The upper portion of the sleeve forms a cylindrical thread relief 48 and integrally connects with a flange-like head 50. The underside of the head includes an annular planar smooth surface 52 which is generally commensurate with and receivable against the recess annulus 29. A circumferential serrated surface 54 adjacent the underside of the head is generally coaxial with the sleeve. Surface 54 preferably forms 24 equiangularly spaced serrations.

The upper portion of the head includes a tapered surface 56 which terminates in a peripheral rim 58 and an inwardly dual angled surface 60 which descends to a position adjacent the end of the throughbore 44. A pair of opposed oblique slots 62 are formed in the bi-level surface. Equiangularly spaced shallow dimples 66 are angularly arranged and defined in the upper surface.

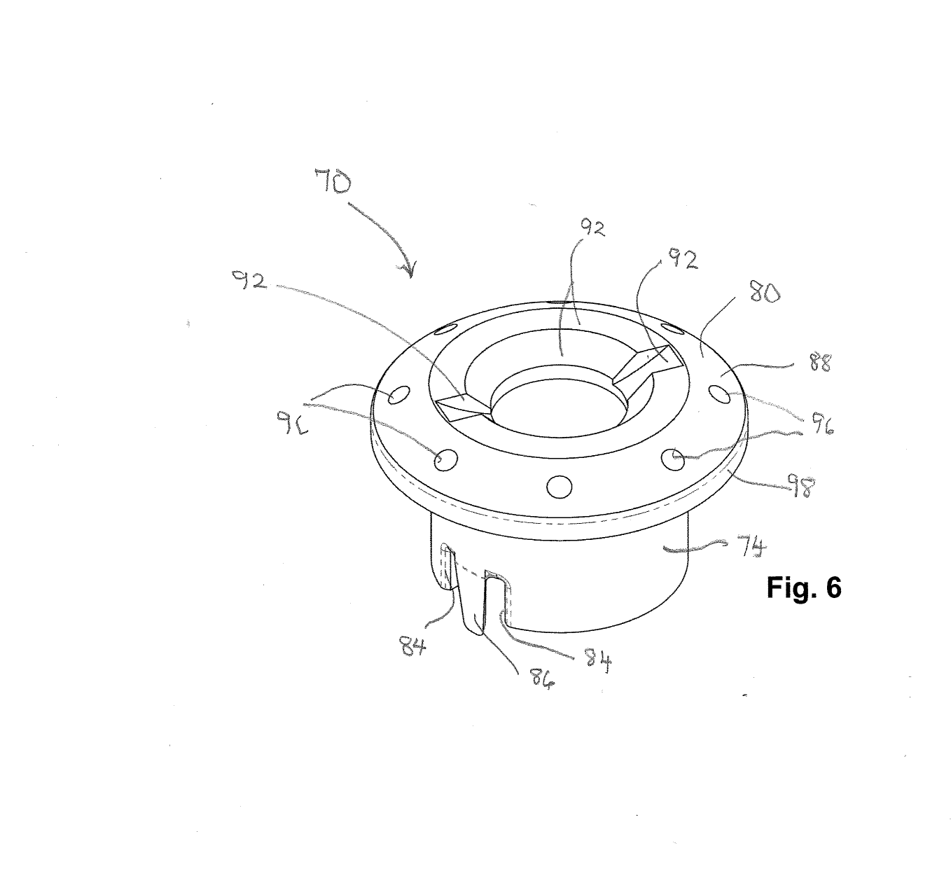

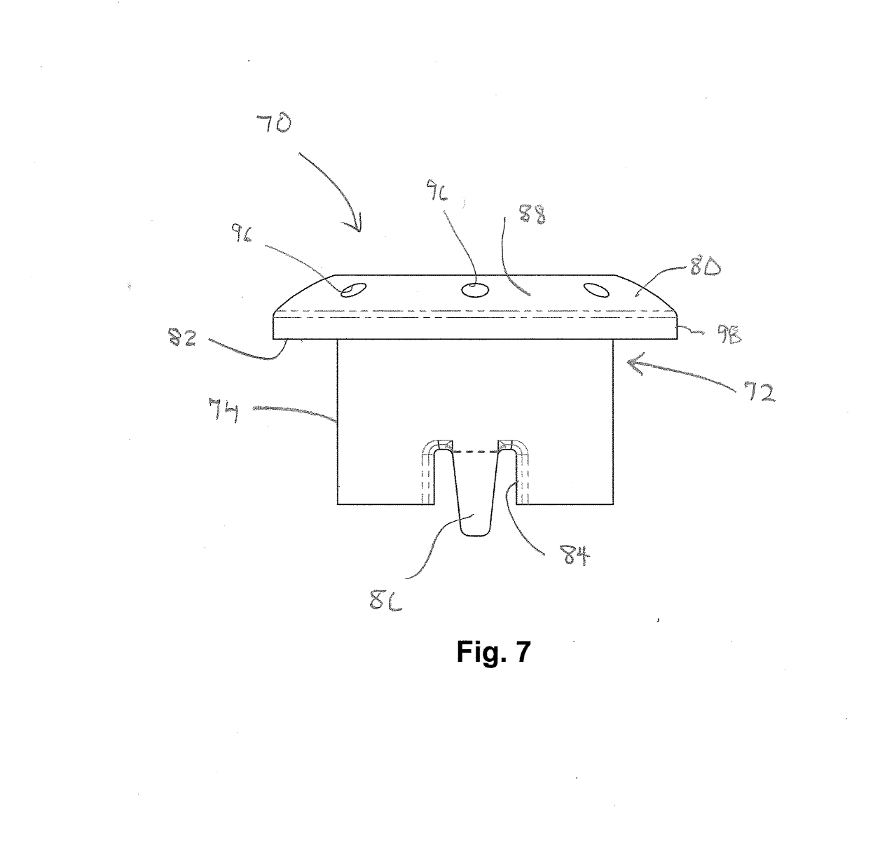

With reference to FIGS. 6-9, the female hub nut 70 includes an upper sleeve 72 with a cylindrical exterior surface 74 which has a diameter commensurate with the diameter of the pivot openings 26 and 36 of the thumb and finger subassemblies. The interior surface of the female hub nut is tapped to form a thread 76 complementary with the thread 46 of the male member. The thread 76 generally extends to a lip 78 at the end of surface 76.

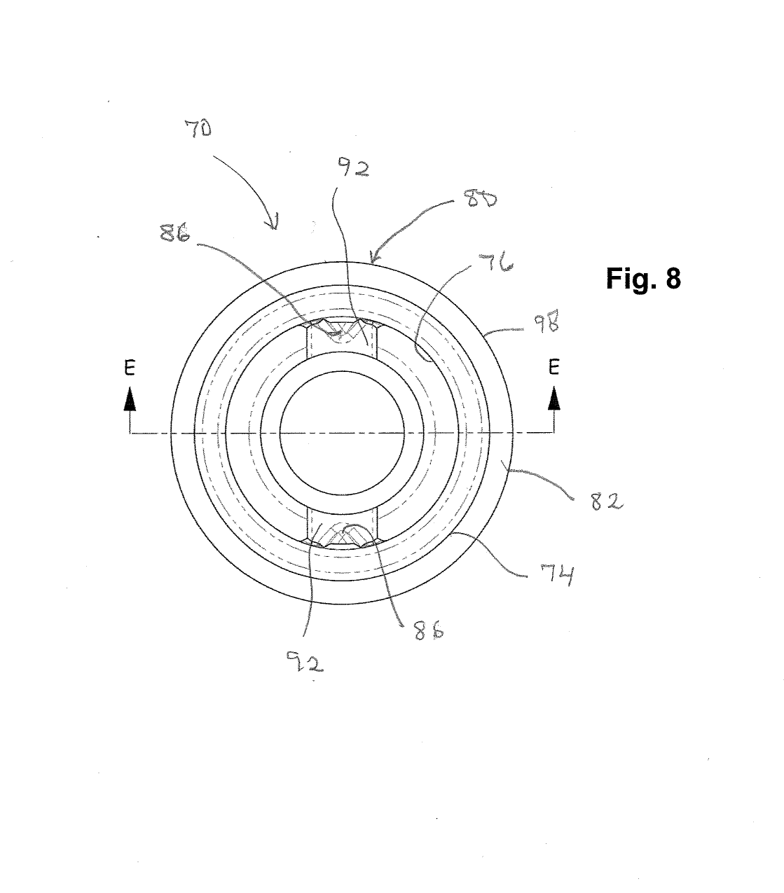

A lower head 80 of the female hub is substantially identical to head 50. Head 80 includes a flange-like portion which has a smooth top side surface 82 generally commensurate in shape and dimensions with the surface 39 of the recess 38 of the finger subassembly. The top of the sleeve includes opposed cutouts 84. An integral resilient ratchet pawl 86 projects into and beyond each cutout. Each ratchet pawl 86 is biasable against the serrated surface 54 to provide a locking-type ratchet arrangement. The pawls 86 have a generally radially inward V-shaped construction (FIG. 8).

The lower head 80 of the female member 70 includes a contoured surface 88 and a peripheral rim 98 which is substantially equal in shape and dimension to that for the male hub nut. The bottom surface also includes a dual angled surface 90 which is interrupted by opposed slots 92. Equiangularly spaced shallow dimples 96 are defined in the surface 88.

The pivot assembly is assembled by inserting the female member 70 from the underside of the finger subassembly into opening 36. The thumb subassembly 20 is laid over the finger subassembly 30 and the openings 26 and 36 are aligned. The male hub nut 40 is then threadably engaged to the female hub nut 70 and, as the hubs engage, the ratchet pawls 86 engage detents of surface 54 to lock the engagement.

It will be appreciated that the diameter of the exterior sleeve surface 74 of the female nut is substantially commensurate with the diameter of the pivot opening 36. Exterior surface 74 is smooth and functions as the rotational or pivotal bearing surface for the pivoted thumb loop subassembly 20 and finger loop subassembly 30. The surface of the male hub nut 40 engages annulus 29 of the thumb opening and surface 82 of the female hub nut 70 engages annulus 39 to clamp the scissors together.

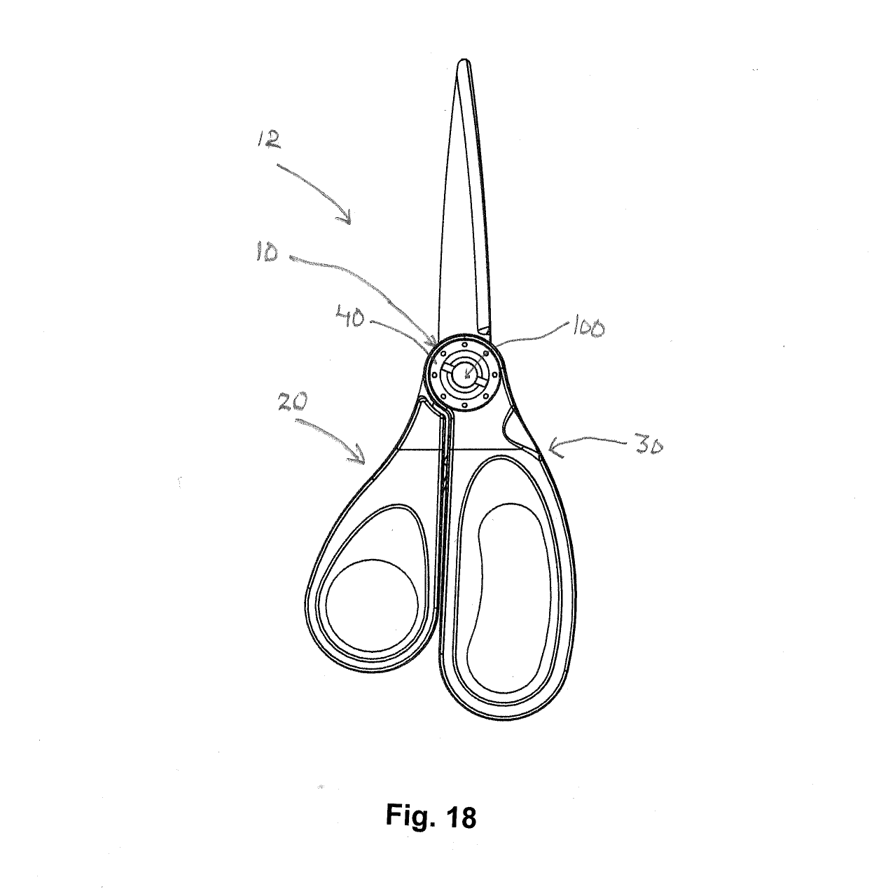

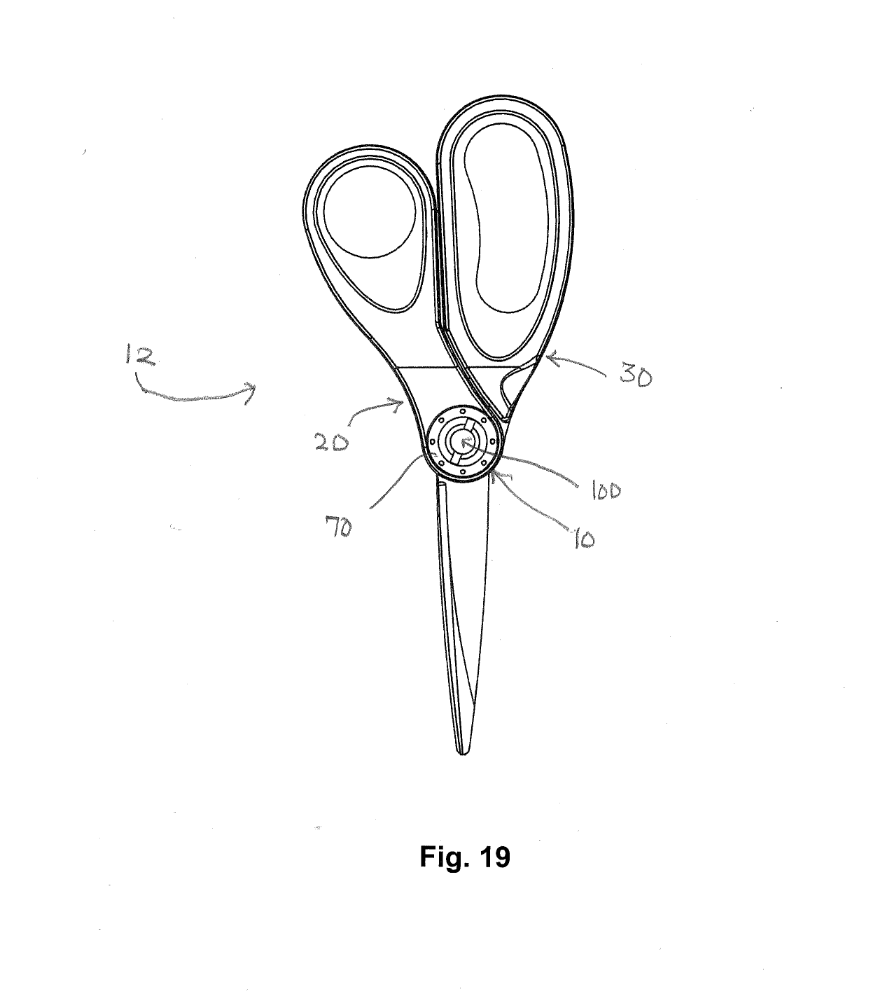

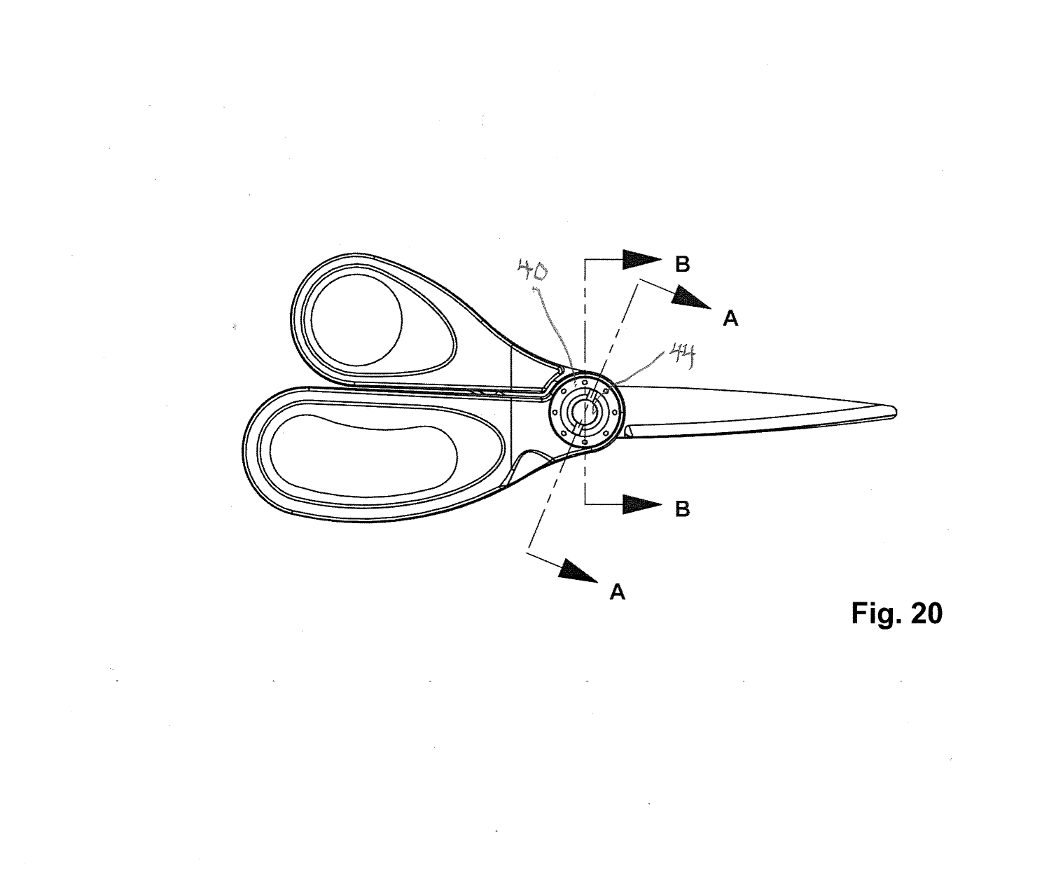

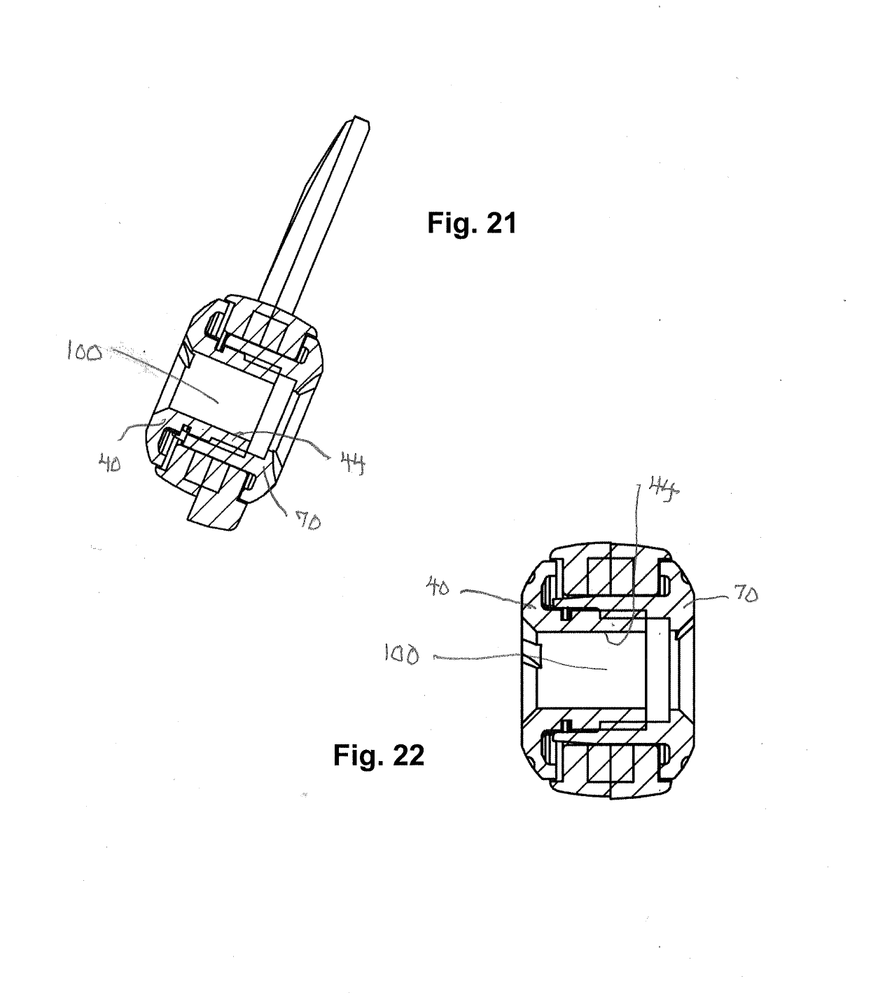

With reference to FIGS. 18-22, a throughbore 100 extends through the female and male hub nuts and is essentially defined by the central bore 44 of the male member.

The slots 62 and 92 are adapted to receive a coin or other tool on opposed sides of the male hub nut and the female hub nut, which can allow for tightening or loosening of the threaded and ratchet engagement as desired.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A low friction hub for pivotally connecting a pair of scissors comprising:
a first hub nut comprising:
a sleeve defining a cylindrical bore and having an exterior threaded surface and a circumferential serrated surface;
a head integrally extending at a bottom of said sleeve and defining an annular shoulder projecting radially from said sleeve and having a tapered upper surface terminating in a peripheral rim and having an inwardly angled surface adjacent said bore and interrupted by a pair of opposed slots;
a second hub nut comprising:
a sleeve having a cylindrical exterior surface and defining an interior threaded bore and opposed axially projecting pawls;
a head integrally extending at a bottom of said sleeve and defining an annular shoulder projecting radially from said sleeve and having a tapered lower surface terminating in a peripheral rim and having an inwardly angled surface adjacent said threaded bore and interrupted by a pair of opposed slots;
wherein said second hub nut threadably receives said first hub nut so that said pawls engage said first hub nut serrated surface and a central throughbore traverses through said first and second hub nuts.

2. The low friction hub of claim 1 wherein said pawls each have a V-shaped section.

3. The low friction hub of claim 1 comprising an annular recess disposed between said serrated surface and said exterior threaded surface of said first hub nut.

4. The low friction hub of claim 1 wherein said first hub nut head and said second hub nut head are substantially identical.

5. The low friction hub of claim 4 further comprising a plurality of angularly spaced dimples defined in said first hub nut head and said second hub nut head.

6. A low friction hub for pivotally connecting a pair of scissors comprising:
a first hub nut comprising:
a sleeve defining a cylindrical bore and having an exterior threaded surface and a circumferential serrated surface;
a head integrally extending at a top of said sleeve and defining an annular shoulder projecting radially from said sleeve and having an upper surface terminating in a peripheral rim and extending to said cylindrical bore;
a second hub nut comprising:
a sleeve having a cylindrical exterior surface and defining an interior threaded bore and at least one axially projecting pawl;
a head integrally extending at a bottom of said sleeve and defining an annular shoulder projecting radially from said sleeve and having a lower surface terminating in a peripheral rim and extending to said threaded bore;
wherein said second hub nut threadably receives said first hub nut so that at least one pawl engages said first hub nut serrated surface and a central throughbore traverses through said first and second hub nuts.

7. The low friction hub of claim 6 wherein there are two opposed pawls, each having a V-shaped section.

8. The low friction hub of claim 6 further comprising an annular recess disposed between said serrated surface and said exterior thread surface of said first hub nut.

9. The low friction hub of claim 6 wherein said first hub nut head and said second hub nut head are substantially identical.

10. The low friction hub of claim 6 wherein each said head defines a pair of opposed slots.

11. The low friction hub of claim 6 wherein said upper surface of each said hub extends inwardly toward said throughbore.

12. A pair of scissors comprising:
a lever-like first subassembly defining a first circular opening having a first diameter and a first annular surface surrounding said first opening;
a lever-like second assembly defining a second circular opening having a diameter equal to said first diameter and a second annular surface surrounding said second opening;
a first hub nut comprising:
a sleeve defining a cylindrical bore and having an exterior threaded surface and a circumferential serrated surface;
a head integrally extending at a top of said sleeve and defining an annular shoulder projecting radially from said sleeve and having an upper surface terminating in a peripheral rim and having an inward surface adjacent said bore and interrupted by a pair of opposed slots;
a second hub nut comprising:
a sleeve having an exterior cylindrical surface having a diameter substantially equal to said first opening diameter and defining an interior threaded bore and opposed axially projecting pawls;
a head integrally extending at a bottom of said sleeve and defining an annular shoulder projecting radially from said sleeve and having a lower surface terminating in a peripheral rim and having an inward surface adjacent said bore and interrupted by a pair of opposed slots,
wherein said second hub nut threadably receives said first hub nut so that pawls engage said first hub nut serrated surface and a central throughbore traverses through said first and second hub nuts to secure said first subassembly to said second subassembly wherein said first hub nut annular shoulder engages said first annular surface and said second hub nut annular shoulder engages said second annular surface.

13. The scissors of claim 12 wherein said pawls have a V-shaped section.

14. The scissors of claim 12 wherein said head of said first hub nut and said head of said second hub nut are substantially identical.

15. The scissors of claim 12 wherein said second hub nut defines an inward lip and said bore is threaded to a position adjacent said lip.

16. The scissors of claim 12 wherein said slots are oriented obliquely relative to each of said head.

17. The scissors of claim 15 wherein said upper surface and said lower surface each defines a plurality of equiangularly spaced dimples.

18. The pair of scissors of claim 12 wherein said throughbore is defined by said cylindrical bore of said first hub nut.

19. The pair of scissors of claim 12 wherein said exterior cylindrical surface of said second hub nut is adjacent the thumb assembly defining a first circular opening and the finger assembly defining the second circular opening and functions as a rotational bearing.

20. The pair of scissors of claim 12 wherein said first hub nut sleeve defines an annulus between said serrated surface and the exterior threaded surface and said serrated surface comprises 24 equiangular spaced serrations.
